(19) United States
(12) Patent Application Publication
(10) Pub. No.: US 2014/0018127 A1
(43) Pub. Date: Jan. 16, 2014

(54) METHOD AND APPENDAGE FOR RETROFITTING A MOBILE PHONE TO USE SAME FOR NAVIGATING A COMPUTER ENVIRONMENT

(71) Applicants: Gilad Meiri, Cupertino, CA (US); Ori Shashua, Herzliya (IL)

(72) Inventors: Gilad Meiri, Cupertino, CA (US); Ori Shashua, Herzliya (IL)

(73) Assignee: Tynics, LLC, Cupertino, CA (US)

(21) Appl. No.: 13/545,318

(22) Filed: Jul. 10, 2012

(51) Int. Cl. H04W 88/02

(52) U.S. Cl. 455/556.1

(57) ABSTRACT

An appendage for coupling to a mobile phone for retrofitting the mobile phone, said appendage comprising a location sensor that enables use of the mobile phone as a computer mouse for navigating within a computer environment graphic user interface on a computer.

### FIELD OF THE INVENTION

The present invention is directed to a method and system for navigating in a computer environment, particularly for navigating about a computer environment in conjunction with a portable computer, such as a laptop or notebook computer.

### BACKGROUND OF THE INVENTION

Apocryphal to the Computer revolution is the invention of the computer mouse, apparently by a team at Xerox. A couple of decades before its time, the computer mouse came off patent just as text based operating systems such as DOS were phased out and replaced by Windows™ as the ubiquitous operating system, and the computer mouse became virtually indispensible for navigating virtual space on a computer screen.

Navigation in general and the position of the cursor in particular, can also be controlled with cursor control buttons and computer keyboards sometimes include scroll wheels and the like that also enable navigation. Portable computers such as ‘notebook’ or ‘laptop’ computers often include self-contained touch pads but these are generally less convenient than an external mouse and many users will attach an external mouse to their laptop computer at the first opportunity as long as they are working at a table or the like and have an available surface to serve as a mouse pad.

There is, however, something intensely unsatisfying about working with a notebook or laptop computer that is supposed to be portable, together with an external mouse. The portable solution is supposed to avoid connections and trailing wires and the external mouse requires a wire connection. Furthermore, the external mouse is an additional component to pack. In size, the portable computer is now little more than an electronic notebook the size of a pad, and the mouse is a space-occupying additional element that is another article for the user to carry around, or worse, to forget behind, making operation of the portable computer awkward and inefficient.

Korean Patent Application Number KR3079883A titled “Method for Using Mobile Phone as Mouse and Method for Connecting to Web Site Using Button” describes a method for using a mobile phone as a mouse and a method for connecting to a web site using a button thereon, to use the mobile phone as a wireless optical mouse and to use the button mounted on the mobile phone as an Internet access button, and thereby to access and surf the Internet conveniently.

In the solution described in KR3079883A, a wireless transmitting/receiving device, an optical sensor, and a mouse button are mounted in a mobile phone. A numeral button signal, an optical sensor signal, and a mouse button signal of the mobile phone are transmitted to driver software stored in a computer through a wireless path. An Internet address is designated in the numeral button. Driver software of a mobile phone mouse is installed in the computer. An address of the software processed by the numeral button signal of the mobile phone mouse through the computer is recognized. If an address of the numeral button signal is identical with the address of the software, synchronization is executed. In the synchronization stage, an Internet address stored in the software is executed through the computer, and a web site is displayed on a display device connected to the computer.

Using a mobile phone as a mouse is one highly efficient way of dispensing with the need to carry a mobile phone, a portable computer and a separate mouse whilst nevertheless retaining the full functionality and convenience of a regular computer mouse. However, it appears that in the solution described in KR3079883 a special mobile phone is required. This limits the mobile phone somewhat and many users update or otherwise change their mobile phones very frequently.

UK Patent Number GB2377592—titled “Portable Telephone Set” describes a portable telephone set, such as a mobile phone for example, which has a control unit that detects output signals from a mouse, to move the display screen or specific information on a same plane of the display section. Essentially, this application relates to a mobile phone which has a mouse like user input device (not shown), such as a track ball mouse or an optical mouse, which can be used to control a display of the mobile phone. Additionally, the phone can be associated with an external device, such as a laptop computer 107, via a cable 106 or wireless connection (radio/Bluetooth) and used as a mouse type input device for the laptop.

International patent publication number WO05045608, titled “System and Method for Establishing a Communication between a Peripheral Device and a Wireless Device” describes a system for communication between a peripheral device and wireless device, and has a wireless device whose operating system links resident programs with a peripheral device, when the peripheral device communicates with computer platform. Essentially, a system, method and computer program for establishing communication between a peripheral device and programs resident on a wireless computer device is provided. The device has a computer platform with a wireless communication portal and one or more resident programs, and the computer platform includes an operating system that manages wireless device resources and the interaction of the wireless device with other computer devices. When a peripheral device selectively communicates with the computer platform of the wireless device via a wired or wireless communication, the operating system of the wireless device identifies at least the type of peripheral device and links the peripheral device with one or more of the resident computer programs.

It will be appreciated that there are mutually contradictory design requirements for the computer mouse, particularly when used with the portable computer. It is required to have all the ergonomic utility and functionality of the regular computer mouse but not to take up space in the case. The present invention addresses these mutually exclusive requirements.

### SUMMARY OF INVENTION

A first aspect of the invention is directed to providing an appendage for coupling to a mobile phone for retrofitting the mobile phone; the appendage comprising a location sensor and draws power from the mobile phone, enabling use of the mobile phone as a computer mouse for navigating within a computer environment on a computer.

Typically, the computer will be a lap top computer or a notebook computer, but may be a desk top or tower computer or a workstation.

Optionally the computer environment is a graphic user interface,

In one embodiment, the appendage is coupled by a lead to a mouse port of the computer.

In another embodiment, the appendage is coupled by a lead to a USB port of the computer.

Optionally, the lead facilitates recharging of the mobile phone.

Optionally, the appendage is in data communication with the portable computer via a communication protocol.

Optionally, the sensor is selected from the group comprising: (i) optical emitters and receivers, (ii) ultrasound emitters and receivers and (iii) accelerometers.

Optionally, the appendage further comprises a processor for receiving data from the sensor and parsing into a location change for transmission to the portable computer.

Alternatively, the mobile phone is programmed with software for receiving data from the sensor of the appendage and for parsing the data for transmission to the portable computer.

Optionally the appendage further comprises a data transmitter for transmitting location data to the portable computer.

Optionally the appendage further comprises a controller for controlling a transmitter of the mobile phone to transmit position data relative to the computer.

Alternatively, the appendage itself comprises a transmitter for transmitting position data relative to the computer.

Optionally the appendage further comprises a housing at least partially encasing the mobile phone.

Optionally the appendage further comprises at least one button for accepting data input from a user for receiving a control signal for interacting with the portable computer.

Optionally at least one button of the mobile phone is retro-converted to accept data input from a user for receiving a control signal for interacting with the portable computer.

Optionally. at least one sensor of the mobile phone is configured to accept data input from a user for receiving a control signal for interacting with the computer.

In a second aspect, the present invention is directed to providing a method for navigating a graphical user interface of a computer comprising:
(a) retro-fitting an appendage equipped with a location sensor to a mobile phone;
(b) sensing movement with the sensor;
(c) parsing the sensed movement into location changing data;
(d) transmitting the location changing data to the computer.

Typically the computer is a portable computer.

Typically, the method further comprises receiving data input from at least one button of the mobile phone and using the data input to interact with the computer.

Optionally, the parsing is performed by a processor within the appendage.

Alternatively, the parsing is performed by a processor of the mobile phone.

### BRIEF DESCRIPTIONS OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic illustration showing the appendage of the invention attached to a mobile phone and coupled via a blue-tooth connection to a portable computer;

FIG. 2 is a schematic side-view of one embodiment, showing how the appendage can be focused by varying its height vis-a-vis the mobile phone to its focal length;

FIG. 3 is a schematic side view of a second embodiment wherein the appendage includes accelerometer sensors, and

FIG. 4 is a flowchart showing how a virtual computer environment shown on the screen of a mobile computer may be navigated using the appendage of the present invention coupled to a mobile phone.

### DESCRIPTION OF PREFERRED EMBODIMENTS

It will be appreciated that portable computers and mobile phones both have communication and processing capabilities.

For the purpose of the present invention, the term mobile phone relates to a hand-held compact device used for verbal communication and often for short messaging and other service, and includes Palm Pilots, -i-phones and other devices that typically also include a screen for text display, an internal processor providing some processing ability and typically including an internal phonebook, perhaps a rudimentary calculator and perhaps the ability to receive and send text communication and sometimes the ability to surf the internet.

The term computer, as used herein, relates to a device having a screen, and a QWERTY or Dvorak type keyboard, or similar for other alphabets. It includes laptops, notebooks and tablet computers and typically runs a graphical operating system such as Windows, and surfs the Internet more comfortably than mobile phones do. The term computer does include desktop computers, but generally does not relate to such devices that though portable in the sense that they can be moved without special equipment, nevertheless are generally installed in one place and used in one location. It is understood that modern computers allow communication by the Internet and this may include vocal communication via VOIP.

In general, portable computers are usefully provided with an external mouse for ease of navigation through the operating system, programs running thereupon and the Internet. Where a work surface such as a table top is available, the external mouse is more convenient to use than the tracker ball, mouse pad or cursor control keys built into the computer case. However, the external mouse is an additional element to carry around and to pack and unpack.

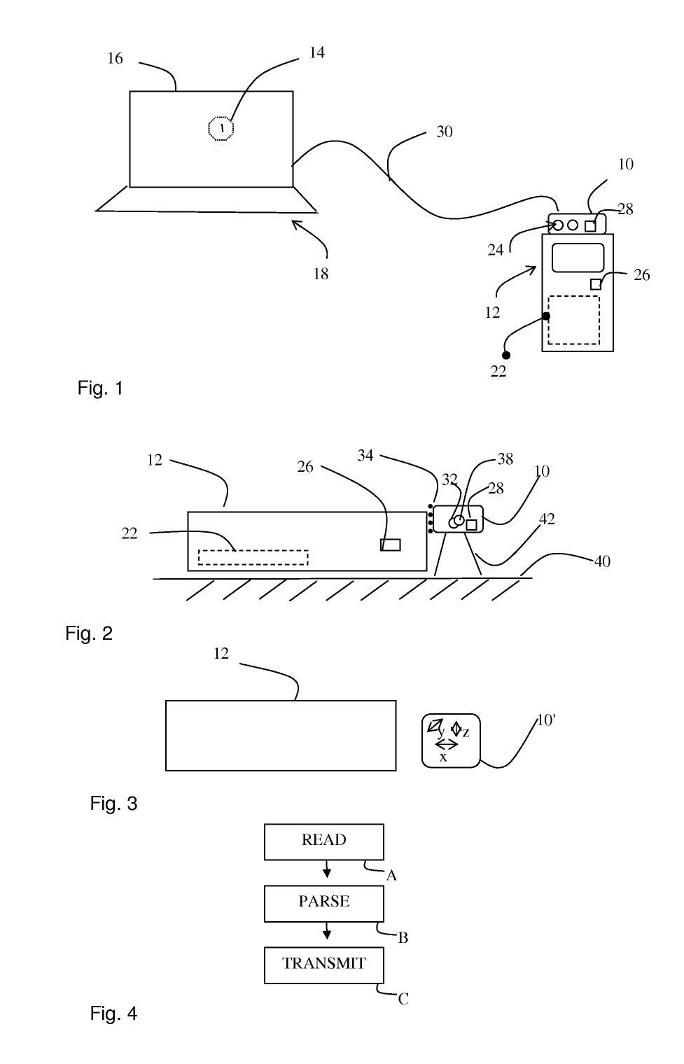

With reference to FIG. 1, the present invention is directed to providing a hardware appendage 10 that is rigidly coupled with a mobile phone 12, typically a smart phone, i.e. a mobile phone 12 with computer processing abilities, thereby allowing the mobile phone 12 to operate as a computer mouse for controlling the on-screen navigation tool, e.g. cursor 14 on the screen 16 of a computer 18, typically a portable computer such as a laptop computer, notebook or tablet computer. The hardware appendage 10 plugs into the mobile phone 12 via a physical connection 20 such as a 30 pin connector, headset plug or the like, or it is physically connected to the mobile phone 12 but communicates therewith in a wireless manner, perhaps via Bluetooth, WIFI or IR connection and the like, and draws power from the battery 22 of the mobile phone 12.

In one embodiment, the hardware appendage 10 has a built in location sensor 24 that senses changes in its location, and sends location data, such as Cartesian or Polar coordinates as the mobile phone 12 is moved around. The location data is parsed into control commands, either via the processor 26 of the mobile phone 12 or by a dedicated processor 28 built into the appendage 10, and transmitted to the computer 18, which is typically a laptop, notebook or tablet etc., where it manipulates an on-screen navigation tool 14, and may also allow other types of data input.

Thus the mobile phone 12 is facilitated to serve as a mouse like device for cursor control and can be used for Windows navigation, Internet surfing, as gaming controls, and similar purposes.

It will be appreciated that the mobile phone 12 has to be programmed with a software application to communicate with the appendage 10. Either the appendage 12 or the mobile phone has to communicate with the computer 18. Although the present invention can work with a regular desktop computer it is particularly advantageous when used with portable computers such as tablets and laptops, where carrying and connecting a mouse is an inconvenience; it being noted that very few users of portable computers do not carry mobile phones.

In one embodiment, the appendage 10 is coupled to the computer 18 by a lead 30. Lead 30 carries data from appendage 10 and phone 12 to the computer 18 and typically couples to the computer via a mouse port or via a USB port.

Optionally, lead 30 enables the mobile phone to be charged from the computer 18.

Appendage 10 may include a sensor 24 for sensing location. There are a number of ways that this may be implemented.

In one family of embodiments, the sensor comprises a light emitter and detector, that may be IR, optical or an other wavelength, and which sends a light signal that is returned from a surface as in a prior art optical mouse. The emitter may be a light emitting diode (LED) or a laser, for example.

In alternative embodiments, the appendage 10 emits a sound wave, typically having an ultrasonic frequency, such as a piezoelectric crystal, for example and includes a corresponding ultrasonic detector and thus operates by a sonar technology.

In further alternative embodiments, the position and movement of the appendage 10 in space is tracked using an internal accelerometer. This technology is well established and is used in gaming tools such as the Wii and in Apple I-phones. Preferably the internal accelerometer also measures velocity of movement.

In one embodiment, the appendage 10 provides X-Y positioning and the internal accelerometer of the mobile phone 12 to which it is coupled provides an additional degree of freedom, whether Z direction motion or tilt, that provides an additional channel for data input to the computer 18, whether for controlling the cursor 14 on the screen 16 of the computer 18, or for otherwise interacting with the computer 18, for example.

In general, integrating data from the sensors of the appendage 10 with data from the built in sensors of the mobile phone 12 enables advanced control methods such as gestures recognition, three dimensional motion control, video control, and, where the mobile phone provides voice recognition, may provide voice control.

In one configuration, the appendage 10 provides only the required sensors for mouse functionality, tracking motion within a plane. These may be augmented with additional sensors integrated into the mobile phone 12. It is noted that many mobile phones 12, particularly smart phones, have fairly expensive and sophisticated built in sensors; however these are often not sensitive enough to provide regular cursor control without exaggerated hand movements. The combination of the X-Y positioning provided by the appendage 10 with occasional usage of movement or tilt sensors of the mobile phone 12 may provide a strong commercial advantage, and is generally more economical than providing an appendage having, for example, accelerometer based gesture control features.

One example of combining mouse control and additional control from a mobile phone could be using motion gestures to control music playback while writing documents, such that switching to the Next or Previous song in a memory may be accomplished by briefly raising the phone+appendage and tilting the hand to the right or left, rather like controlling an MP3 or MP4 music player by shaking, for example. Alternatively, volume control could be provided by tilting the phone+appendage up and down. Thus it will be appreciated that the appendage 10 and/or mobile phone 12 may be used for navigating through a sound track, and not just for navigating through graphical worlds or textual documents.

For text editing, the cursor control provided by the sensors of the appendage 10 could be combined with voice recognition offered by the mobile phone 12, to edit a document on the screen 16 of the computer 18, for example, to control the cursor 14, where speech recognition of the mobile phone 12 could be used for formatting, for example saying “Bold” or “Underline” would apply formatting to text marked by cursor; saying “copy” or “paste” could copy or paste text selected by the cursor 14. These are examples, only. Other functions such as changing language could be achieved by voice command using voice sensors of the mobile phone 12. Similarly, any other sensor built into the phone could be programmed to interact with the computer 18, typically but not limited to controlling the display on the screen 16.

It will be appreciated that different mobile phones have different dimensions. The sensor 24, if rigidly positioned vis a vis the body of the mobile phone 12, will correctly operate as a mouse, regardless of where the sensor is situated in the plane parallel to the surface 40 on which the mobile phone 12 is moved. Nevertheless, for some sensors 24, correct operation requires a carefully adjusted, fixed height above the surface 40. For such sensors 24, one solution is for the sensor 24 to be mounted within a hollow mount 42 whose mouth 44 is always in contact with the surface 40, tilting the body of the mobile phone 12 up and away from the surface 40.

Alternatively, the position of the appendage 10 may include an adjustment means 34 for varying the position of the sensor with respect to the casing of the mobile phone 12 in a direction perpendicular to the surface over which the mobile phone 12 glides as a mouse, thereby ensuring that the sensor 24 is at the right altitude over the surface 40. This gives the built-in location sensor 24 the ability to be moved in relation to the appendage 10 and mobile phone 12 to achieve the required conditions for its correct operation, for example so that where sensor 24 is an optical sensor it is positioned at the optimal focal distance required for it to operate. The adjustment means 34 may be purely mechanical, purely electronic or a combination of mechanical and electronic.

As shown in FIG. 2, in one embodiment, the appendage includes a vertical adjustment means 34 such as a ratchet and pinion gear to physically adjust its position in relation to the mobile phone's dimensions so that the sensor 24 is positioned at the required altitude above the surface 40.

In an Optical-Mechanical embodiment, the sensor 24 includes a light emitter 36 such as a light emitting diode LED, a light receptor such as a CCD or CMOS detector 38 and a lens 32 whose altitude may be shifted with relation to the distance from the surface 40 to focus the system properly. In other electronic embodiments, the sensitivity/threshold point of the sensor may be changed in accordance with changes in the input to the sensor 24 caused by varying its position relative to the surface 40.

As shown in FIG. 3, in some embodiments, the appendage 10 includes internal accelerometers, location changes in three dimensions X, Y, Z may be tracked, and this enables gaming and other purposes. Optionally, the software application is programmed to use location data received from the appendage in conjunction with data received from other sensors (ex. accelerometer) in the mobile phone in order to generate location information in more than two dimensions and this functionality may be used to control user defined parameters in games or applications running on the portable computer 18 and viewed as the cursor 14 on the screen 16 thereof.

With additional reference to FIG. 4, the sensor 24 of the appendage 10 generates the location data which is read (step A) by a program 46 running on the mobile phone 12. The program 46 is typically a software application. The program 46 parses (step B) the location data into control commands that are transmitted to (Step C) the portable computer 18 device via a lead 30 or wireless protocol such as Bluetooth, wifi, 3G or a radio signal.

In one embodiment, data from the appendage 10 is transferred to the mobile phone 12 via a communication channel, which may be a hard wired communication channel, such as through a lead connected to a charging plug, a headset plug or data connector, or via a cordless communication channel such as WIFI, Bluetooth, and the like.

Additionally of alternatively, embodiments of the appendage may communicate directly, via a lead 30 or via a wireless communication protocol, with the portable computer 18.

In addition to the location sensor 24 and the ability to transmit location information, the combination of appendage 10 and mobile phone 12 is provided with one or more buttons 50, 52, 54 for data input and preferably with one or more scrolling tools 56 that can serve as a mouse wheel. These buttons 50, 52, 54 and/or scrolling tool 56 may be buttons of the mobile phone 12, touch screen virtual buttons on the screen of the mobile phone 12, or buttons 50 on the appendage 10, which may extend over part of the mobile phone 12 and partially encase same.

The combination of appendage 10 and mobile phone 12 may provide a plurality of buttons for editing and navigation and not merely the one or two buttons of the simplest type of mouse. Indeed, each button of the mobile phone 12 may be programmed with one or more functions. In touch screen phones, it will be appreciated the user has almost unlimited freedom to add buttons wherever he likes.

In preferred embodiments, the user may configure the functionality of the buttons of the mobile phone for controlling the cursor 14 and other purposes in accordance with personal preferences.

The appendage 10 may be configured as a cover or case for the mobile phone 12.

To minimize friction and wear, legs or spacers may be provided to minimize or prevent scratching the case of the mobile phone 12 as it is slid over the surface 40.

Additional Features of Select Embodiments

It will be appreciated that for various purposes, particularly gaming, three-dimensional navigation is desirable. Embodiments of the invention provide control over the Z axis by integrating the mouse sensor and the accelerometer of the mobile phone—so that when moving the mobile phone itself the software can transmit moving command on additional axes (example-the z-axis). This is applicable to various applications and uses such as graphic design, gaming, shifting between windows, zooming in and out and the like.

Motion pattern analysis of the appendage and mouse may enable user recognition, which may be accomplished in a manner such as is used for signature identification, for example. This may be applied to various security applications such as studying and analyzing behavioral motion, the patterns of the mouse and for creating a “motion pattern fingerprint” that will help authenticating the identity of a user and permit logging in to a service or unlocking the PC.

Some embodiments allow a touch-screen phone to be used as a mouse pad.

The combination of appendage 10, mobile phone 12 and computer 18 may provide the user with the capability to share his computer screen 16 with a remote user. For example, a computer application may send a screen capture of the screen 16 as data to the mobile phone 12. An application of the mobile phone 12 may utilize the Internet connectivity of the mobile phone to allow a remote service or user to view the screen capture.

It will be appreciated that each person moves his mouse in a unique way. By analyzing motion patterns collected by the appendage 10 one may be able to authenticate the user currently using the computer, for example to log the user in to a controlled computer environment or a remote service.

Other, more exotic possibilities may be considered. For example, in one embodiment, the appendage case dongle includes openings that enable air to pass through.

One such opening can be used as an air inlet through which the user may blow air.

A second opening is positioned so that it directs the blown air onto the mobile phone microphone. Such embodiments may translate a characteristic of the air flow such as its pressure or velocity into another channel/axis of control data or to provide feedback to the user.

The term lead as used herein relates to a wire for carrying data or power or both.

Features shown with some specific embodiments may be incorporated with other embodiments. Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. An appendage for coupling to a mobile phone for retrofitting the mobile phone said appendage comprising at least one location sensor and enabling use of the mobile phone as a computer mouse for navigating within a computer environment graphic user interface on a computer.

2. The appendage of claim 1, wherein the computer is a portable computer.

3. The appendage of claim 1 further comprising a lead. For coupling to the computer.

4. The appendage of claim 3, wherein the lead couples to a mouse port of the computer.

5. The appendage of claim 3, wherein the lead couples to a USB port of the e computer.

6. The appendage of claim 5, wherein the lead allows recharging of the mobile phone.

7. The appendage of claim 1, wherein the appendage is powered by the mobile phone.

8. The appendage of claim 1 being coupled to the computer via a wireless communication protocol.

9. The appendage of claim 8 wherein the communication protocol is selected from the group comprising wifi, Bluetooth or WIMAX.

10. The appendage of claim 1 wherein the sensor is selected from the group comprising an optical emitter and receiver, an ultrasound emitter and receiver and an accelerometer.

11. The appendage of claim 1 wherein the appendage further comprises a processor for receiving data from the sensor and parsing the data into a change of location for transmission to the computer.

12. The appendage of claim 1 wherein the mobile phone is programmed with software for receiving data from the sensor of the appendage and for parsing the data for transmission to the computer.

13. The appendage of claim 1 further comprising a data transmitter for transmitting location data to the computer.

14. The appendage of claim 1, comprising a controller for controlling a transmitter of the mobile phone to transmit data related position to the computer.

15. The appendage of claim 1 further comprising a housing at least partially encasing the mobile phone.

16. The appendage of claim 15 further comprising at least one button for accepting data input from a user for receiving a control signal for interacting with the computer.

17. The appendage of claim 15 for retro-converting at least one button of the mobile phone to accept data input from a user for receiving a control signal for interacting with the computer.

18. The appendage of claim 15 wherein at least one sensor of the mobile phone is configured to accept data input from a user for receiving a control signal for interacting with the computer.

19. A method of navigating a graphical user interface of a computer comprising:
(a) retro-fitting an appendage equipped with a location sensor to a mobile phone;
(b) sensing movement with the sensor;
(c) parsing the sensed movement into location changing data;
(d) transmitting the location changing data to the computer.

20. The method of claim 19 further comprising receiving data input from at least one button of the mobile phone and using the data input to interact with the computer.

21. The method of claim 19 wherein the parsing is performed by a processor within the appendage by a processor of the mobile phone.
